(19) United States
(12) Patent Application Publication
(10) Pub. No.: US 2023/0289591 A1
(43) Pub. Date: Sep. 14, 2023

(54) METHODS AND DEVICES FOR AVOIDING MISINFORMATION IN MACHINE LEARNING

(71) Applicant: Telefonaktiebolaget LM Ericsson (publ), Stockholm (SE)

(72) Inventors: Kristijonas CYRAS, San Jose, CA (US); Alexandros NIKOU, Stockholm (SE); Konstantinos VANDIKAS, Solna (SE); Lackis ELEFTHERIADIS, Valbo (SE); Alessandro PREVITI, Stockhom (SE)

(73) Assignee: Telefonaktiebolaget LM Ericsson (publ), Stockholm (SE)

(21) Appl. No.: 18/001,786

(22) PCT Filed: Jun. 15, 2020
(86) PCT No.: PCT/EP2020/066483

§ 371 Date: Dec. 14, 2022

(51) Int. Cl. G06N 3/08

(52) U.S. Cl. CPC G06N 3/08

(57) ABSTRACT

Methods and sewer nodes generate machine learning models using models trained locally while avoiding misinformation by selectively aggregating models trained locally using data stored in client devices, which are connected to the server node via a communication network. The client devices receive an initial model and return updated model parameters of a respective model locally trained. Logical explanations are obtained, for each of the client devices, based on the updated model parameters and at least one set of input and corresponding output values. A distance based on the logical explanations, for each client device in a secondary cluster, measures a deviation of the respective model relative to model(s) of client devices in a primary cluster. The output model is generated by selectively aggregating at least the models received from the client devices in the primary cluster, while assessing each client device in the secondary cluster based on the distance thereof.

### TECHNICAL FIELD

The present inventions generally relate to generating a machine learning, ML, model while avoiding misinformation by selectively aggregating models trained locally using data stored in client devices.

### BACKGROUND

As datasets grow larger and models become more complex, training machine learning models increasingly requires distributing the training over multiple machines/nodes. Federated learning is a machine learning (ML) technique (as described, for example, in the 2017 article, “Communication-Efficient Learning in Deep Networks from Decentralized Data,” by H. B. McMahan et al., published in Proceedings of the 20th International Conference on Artificial Intelligence and Statistics, which can be retrieved as arXiv:1602.05629) that aggregates models trained across multiple client devices that store data samples, without exchanging or transferring the data samples, which are local to those client devices. For example, using such a federated learning technique a global model is updated as follows: (1) selected data-storing client devices receive an initial/current model (all devices receive the same model) from a server node (sometimes called “central node,” “server computing device,” “lead node” or “aggregator”); (2) each of the selected client devices generates an updated model (or, in other words, trains the received model) using their local data, without uploading the local data to the server node; (3) the locally updated models (e.g., their updated parameters) are transmitted to the server node; and (4) the server node aggregates the updated models (e.g., by averaging) to generate the global model.

The federated learning approach differs from traditional centralized machine learning techniques where all of the data local to the client devices used to train the model is uploaded to the server node, as well as from classical decentralized approaches which assume that local data samples are identically distributed.

One of the challenges in federated learning is “poisoning,” a term used for a scenario in which one or more client devices send (intentionally or not) potentially misleading information to the server node. One such scenario is a Gaussian attack (or gaussian noise) in which a model parameter is replaced with a random value from a gaussian distribution; such an attack potentially reduces the predictive capability to something that is random (i.e., a coin flip). Another scenario is known as label flipping and involves systematically transposing or randomly changing the associations between samples and labels (e.g., what used to be labelled as a “dog” now becomes a “cat”); this scenario does not necessarily decrease predictive power, but it shifts the opinion of the aggregated model.

Conventional methods for addressing this “poisoning” problem associated with the federated learning approach rely on statistical approaches to determine whether new client devices can be trusted or not (i.e., whether and how to integrate their outputs and parameters with outputs and parameters received from trusted client devices). It is desirable to find more efficient methods than conventional statistical approaches to avoid misinformation (i.e., detect poisoning information/client devices) in federated learning and other similar scenarios.

### SUMMARY

Various embodiments of the inventive concepts generate a machine learning (ML) model based on data stored in client devices without transferring the data to the server and while also determining whether new client devices can be trusted by employing a distance based on logical explanations for each of the new client devices. This approach has the advantage that logical explanations (as minimal sets of features) for client predictions guarantee that a client will or will not yield a particular output for a given input, which allows defining a distance metric. The distance metric enables misinformation (i.e., poisoning) to be avoided, thereby providing better control and better performance of an ML model obtained by federated learning.

According to an embodiment, there is a method, performed by a server node, for generating a machine learning, ML, model while avoiding misinformation by selectively aggregating models trained locally using data stored in client devices, which are connected to the server node via a communication network. The method includes providing an initial version of the ML model to the client devices, and receiving, from each of the client devices, updated model parameters of a respective ML model locally trained using the data stored therein starting from the initial version of the ML model. The method further includes obtaining logical explanations based on: (A) the updated model parameters and (B) at least one set of input and corresponding output values for each of the client devices, and then obtaining a distance based on the logical explanations, for each client device in a secondary cluster among the client devices, the distance measuring a deviation of the respective ML model locally trained by the client device in the secondary cluster, relative to one or more ML models trained on the data stored in client devices in a primary cluster among the client devices. The method finally outputs the ML model generated by selectively aggregating at least the updated model parameters received from the client devices in the primary cluster, while assessing each client device in the secondary cluster based on the distance thereof. The method may be embodied in a computer program, and a computer program product comprising a computer readable storage medium storing the computer program.

According to another embodiment, there is a method performed by a server node for generating a neural network, NN, model that predicts whether an equipment of a radio base station is going to fail during a next predetermined interval while avoiding misinformation, by selectively aggregating NN models trained locally using maintenance records of equipment, the maintenance records being stored in client devices connected to the server node via a communication network. The method includes providing an initial version of the NN model to the client devices and receiving updated model parameters of the NN model locally trained on the maintenance records stored by each of the client devices, respectively. The method further includes obtaining logical explanations based on: (1) the updated model parameters and (2) at least one set of input and corresponding output values for each of the client devices, and then obtaining a distance based on the logical explanations, for each client device in a secondary cluster among the client devices, the distance measuring a deviation of the respective NN model locally trained by the client device in the secondary cluster, relative to one or more NN models trained on the maintenance records stored in client devices in a primary cluster among the client devices. The model finally outputs the NN model generated by selectively aggregating at least the updated model parameters received from at least the client devices in the primary cluster, while assessing each client device in the secondary cluster based on the distance thereof.

According to yet another embodiment, there is a server node for generating a machine learning, ML, model based on data stored in client devices in a communication network. The server node includes processing circuitry causing the server node to be operative to provide an initial version of the ML model to the client devices; receive, from each of the client devices, updated model parameters of a respective ML model locally trained using the data stored therein starting from the initial version of the ML model; obtain logical explanations based on the updated model parameters and at least one set of input and corresponding output values for each of the client devices; obtain a distance based on the logical explanations, for each client device in a secondary cluster among the client devices, the distance measuring a deviation of the respective ML model locally trained by the client device in the secondary cluster, relative to one or more ML models trained on the data stored in client devices in a primary cluster among the client devices; and output the ML model generated by selectively aggregating at least the updated model parameters received from the client devices in the primary cluster, while assessing each client device in the secondary cluster based on the distance thereof.

According to yet another embodiment, there is a server node in communication with client devices storing training data. The server node includes: (A) an interface module configured to send an initial version of the ML model to the client devices, and to receive, from each of the client devices, updated model parameters of an ML model locally trained using the data stored therein; (B) a logic-based explained configured to obtain logical explanations based on the updated model parameters and at least one set of input and corresponding output values for each of the client devices; (C) a distance calculator, configured to obtain a distance based on the logical explanations, for each client device in a secondary cluster, the distance measuring a deviation of the respective ML model locally trained by the client device in the secondary cluster, relative to one or more ML models trained on the data stored in client devices in a primary cluster among the client devices; and (D) a federator configured to output the ML model generated by selectively aggregating at least the updated model parameters received from the client devices in the primary cluster, while assessing each client device in the secondary cluster based on the distance thereof.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a federated learning scenario according to an embodiment;

FIG. 2 is a functional representation of the scenario illustrated in FIG. 1 according to an embodiment;

FIG. 3 illustrates a neural network for which explanations are obtained;

FIG. 4 is a flowchart of a method according to an embodiment;

FIG. 5 is a flowchart of another method according to an embodiment;

FIGS. 6 is schematic diagram of an apparatus according an embodiment;

FIG. 7 depicts an electronic storage medium on which computer program embodiments can be stored; and

FIG. 8 is a modular server node according to another embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next incorporate elements of federated learning scenarios but, in fact, are more general, being usable in any scenario in which client devices are validated by measuring distance predictions of a locally trained model to trustworthy predictions.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background section, determining whether new client devices are trustworthy (i.e., the models they provide to not inject misinformation in a global model) remains a challenge. According to the deterministic approach implemented in the following embodiments, models trained by client devices are used to obtain outputs (predictions) for instances (inputs). Previously validated (i.e., trusted) client devices grouped in a primary cluster are the reference for testing the trustworthiness of the new (yet-to-be-validated) client devices grouped in a secondary cluster. Note that in the following description the shortened form “client” or “clients” may be used instead of “client device(s)” but the shorten form is never intended to refer to a person but indicates a network connected client devices. The model parameters received from a new client device are not aggregated if its predictions (i.e., outputs) significantly depart (or do not substantially match) those of models trained by client devices in the primary cluster. To quantify such significant departures, it is calculated a distance between logical explanations obtained from model parameters, instances and predictions for each model.

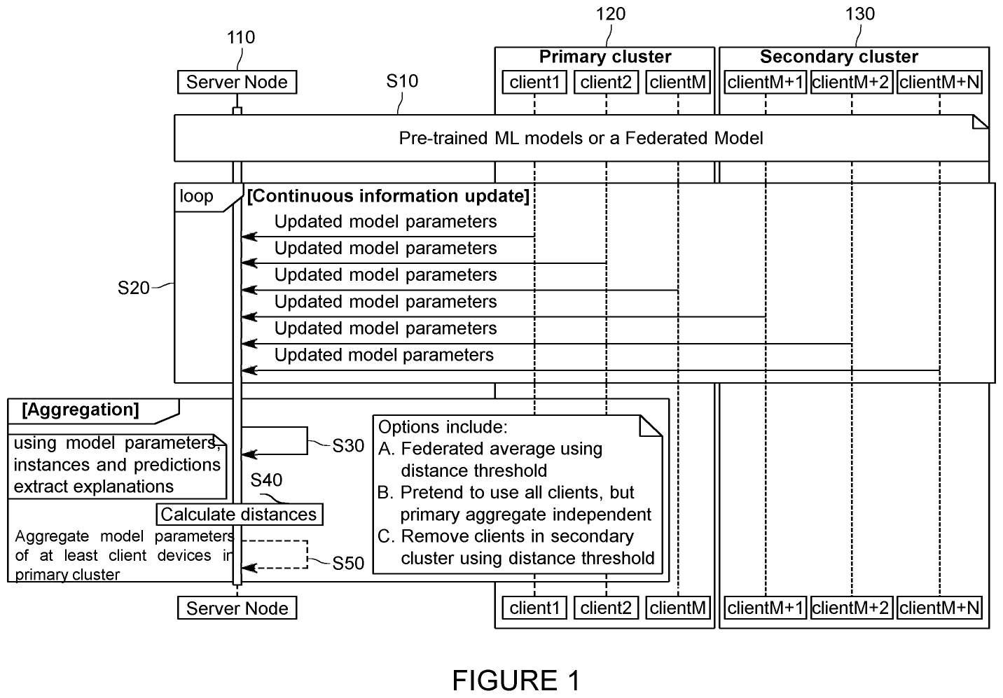

For the sake of clarity, in a federated learning (FL) scenario illustrated in FIG. 1, a server node 110 partitions its clients (i.e., client devices, not people) into two groups: a primary cluster 120 including the trusted clients (client1,client2, . . . , clientM) and a secondary cluster 130 including clients (client M+1, clientM+2, . . . , clientM+N) as yet not validated. In FIG. 1, time flows from top to bottom; that is, operations represented higher in the figure, are performed before those represented lower in the figure. However, it should be understood that other orders of operations may be possible. A client device may be an loT device (i.e., hardware with a sensor that transmits data from one place to another over the Internet, such as, wireless sensors, software, actuators, and computers imbedded into mobile devices industrial equipment, environmental sensors, medical devices, etc.; here loT is an acronym for Internet of Things).

The server node provides the same initial version of a machine learning (ML) model to all the M+N clients at S10. The initial version of the ML model, which is “in-training” at each of the clients, may be a pre-trained ML model or the result of a previous federated learning process. Here “pre-trained” indicates that the initial model (e.g., a neural network) was trained beforehand on data that is not local and not specific to clients (e.g., an initial deployment from factory).

At S20, each of the M+N clients (i.e., both the clients in the primary cluster and the ones in the secondary cluster) returns updated model parameters of the ML model trained locally using data stored in the respective client device. That is, each of the clients trains the initial version of the ML model based on the data stored by the therein to obtain an updated ML model having the respective updated model parameters.

The server node 110 then performs (or causes to be performed as later discussed) steps S30, S40 and S50. At S30, logical explanations (optionally, with guarantees) are extracted for each client based on the updated model parameters (e.g., weights for a neural network model), instances and predictions. Then, at S40, for each of the clients in the secondary cluster, a distance relative to models of the clients in the primary cluster is determined using the logical explanations.

The server node 110 then selectively aggregates the model parameters received from the client devices to generate a global (e.g., federated) ML model at S50. There are multiple ways to aggregate the model parameters received from the clients. In one embodiment, a user indicates which of the available aggregation options is to be used. In another embodiment, ML models corresponding to all the options are output. For example, an option (A) is generating the ML model by aggregating (e.g., using a federated average) the model parameters received from the clients in the primary cluster and the clients in the secondary cluster whose distance relative to the clients in the primary cluster is less than a predetermined threshold.

An option (B) is generating a secondary ML model based on the updated model parameters received from the clients in the secondary cluster, but outputting the ML model based only on the model parameters received from the clients in the primary cluster. Another option, (C), is to remove (i.e., not use) the model parameters of the clients in the secondary cluster whose distance exceeds a pre-defined distance threshold. The models of the removed clients are not aggregated. However, the clients may continue to be used in training and their output may be used later if found trustworthy. Options A-C are exemplary and not intended to be limiting; other options are possible.

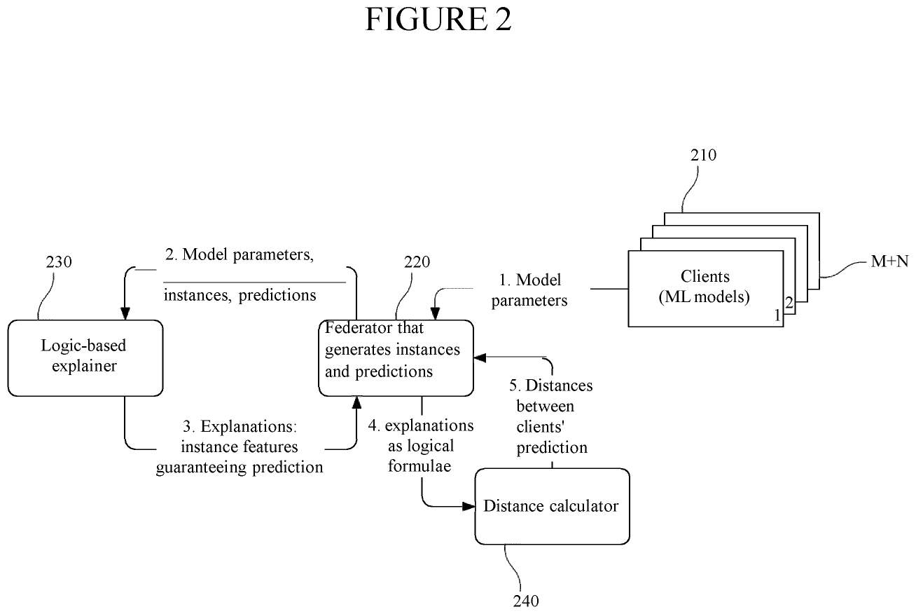

FIG. 2 is a functional representation of the scenario illustrated in FIG. 1 according to an embodiment. Clients (1, . . . , M+N) 210 send updated model parameters to a federator 220. The federator uses known techniques such as deep leakage (described in the 2020 article “iDLG: Improved Deep Leakage from Gradients” by B. Zhao et al., retrivable from arXiv: 2001.02610v1) to create input/output pairs (i.e., instances and predictions) for the federated model and for the client devices in the secondary cluster. The federator forwards the updated parameters, instances and predictions to a logic-based explainer 230, which is a functional module that returns explanations, instance features and guaranteed predictions. The logic-based explainer 230 may be located on the same physical device as the federator 220 or it may run on a different physical device.

In one embodiment, the ML model is a neural network and the model parameters are weights. The logic-based explainer 230 may use logical encodings of neural networks into mixed integer linear programming and extract explanations as minimal sets of input features that guarantee the prediction(s). This logic-based explainer technique is described, for example, in the 2018 article, “Abduction-Based Explanations for Machine Learning Models,” by A. Ignatiev et al. (published in 33^{rd} Association for Advancement of Artificial Intelligence Proceedings, which can be retrieved from DOI: 10.1609/aaai.v33i01.33011511).

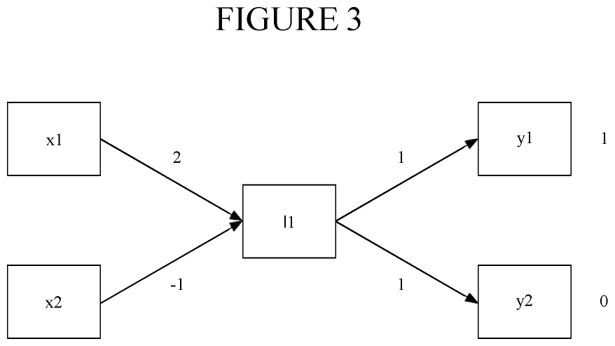

In a simplistic illustration, FIG. 3 illustrates a neural network with inputs (feature values) x1 and x2, I1 value within a node y1 and y2 outputs (i.e., predictions 1 or 0). The logical representation obtained using mixed linear programming is a series of inequalities with variables x1, x2, s1, s2, z1, z2, capturing the model:

2x1−x2−1=y1−s1,

x1+x2+1=y2−s2,

z1=1→y1≤0, z2=1→y2≤0,

z1=0→s1≤0, z2=0→s2≤0,

y1≥0, y2≥0, s1≥0, s2≥0, z1∈{0,1}, z2∈{0,1}.

The explanations consist of selected inequalities.

The federator 220 then collects such explanations carrying theoretical guarantees and sends the instances, predictions and explanations to a distance calculator 240. The distance calculator 240 defines a distance metric over explanations to measure the deviation of models originating from the clients of the secondary cluster from the ones originating from the primary cluster.

To give a concrete example, consider three variables x₁, x₂, x₃ taking integer values in finite domains: x₁, x₂∈{0, 1} and x₃∈[0, 9]∩ [symbol] , and Dᵢ is the domain of xᵢ (i.e. D₀=D₁={0, 1} and D₃=[0, 9]∩ [symbol] . Three logical explanations e₁, e₂, e₃ are the following sets of (in)equalities:

e₁:x₁=0, x2=1, x₃≥2, x3≤5;

e₂:x₁=1, x₂=1, x₃≥2, x₃≤5;

e₃:x₁=0, x₂≥0, x₂≤1, x₃≥2, x₃≤5.

Let x₁(e)⊆Dᵢ be the interval or set of values that xᵢ takes as imposed by e, e.g. x₁(e₁)={0}, x₃(e₁)=[2, 5]. Intuitively, a distance between two logical explanations may be defined by counting the number of values that each variable is supposed to take in one but not the other explanation. Formally, a distance function d between two explanations e, e′ can be defined as follows:

$$d ( e , {e}^{′} ) = {\sum }_{i} \frac{\vert {x}_{i} ( e ) \backslash {x}_{i} ( {e}^{′} ) ⋃ {x}_{i} ( {e}^{′} ) \backslash {e}_{i} ( e ) \vert}{\vert {D}_{i} \vert}$$

where \ denotes set difference, ∪ denotes set union and |·| denotes set cardinality.

For each variable xᵢ, the values that xᵢ is supposed to take in e are removed from the values that xᵢ is supposed to take in e′ then vice versa with e and e′ interchanged. The resulting sets of values are joined, and the joined set's size is divided by the size of the domain Dᵢ. A numerical distance between e and e′ is the sum like this over all variables of the division results.

With the above numerical value, the distance between e1 and e2 is

$$d ( {e}_{1} , {e}_{2} ) = \frac{\vert \{ 0 \} \backslash \{ 1 \} ⋃ \{ 1 \} \backslash \{ 0 \} \vert}{\vert \{ 0 , 1 \} \vert} + \frac{\vert \{ 1 \} \backslash \{ 1 \} ⋃ \{ 1 \} \backslash \{ 1 \} \vert}{\vert \{ 0 , 1 \} \vert} + \frac{\vert [ 2 , 5 ] \text{\textbackslash [} 2 , 5 ] ⋃ [ 2 , 5 ] \text{\textbackslash [} 2 , 5 ] \vert}{\vert [ 0 , 9 ] \vert} = 1 + 0 + 0 = 1 ,$$

$$d ( {e}_{1} , {e}_{3} ) = 0 + \frac{1}{2} + \frac{1}{10} = 0.6 .$$

There may be explanations that do not involve some variables, such as

e₄:x₂=1, x₃≥2, x₃≤5.

The above distance function may be extended to enable distance calculation in this case, penalizing absence of a variable by making it contribute significantly to the distance as follows. First, if xᵢ does not appear in e, then xᵢ(e)=Dᵢ. Then d(e, e′) is defined as

$$d ( e , {e}^{′} ) = {\sum }_{i} \frac{\vert {x}_{i} ( e ) \backslash {x}_{i} ( {e}^{′} ) ⋃ {x}_{i} ( {e}^{′} ) \backslash {e}_{i} ( e ) \vert}{\vert {D}_{i} \vert} + {\sum }_{if {x}_{i} is not in either e or {e}^{′}} \vert {D}_{i} \vert$$

With this definition, distances between explanations e₁, e₂, e₃ remain the same but d(e₁, e₄)=2, so that even though e₂ and e₄ differ from e₁ only in variable x₁ the absence of x₁ in e₄ makes the latter more distant from e₁ than e₂. The above distance function(s) are non-limiting examples of determining distance among objects such as logical explanations. Such distance functions are well known in the art as described, for example, in the 2010 article, “A survey of binary similarity and distance measures,” by S. Choi, published in the Journal of Systemics, Cybernetics and Informatics 8.1, pp. 43-48, and in the 2009 article, “Similarity measures for binary and numerical data: a survey,” by M.-J. Lesot et al., published in the International Journal of Knowledge Engineering and Soft Data Paradigms 1.1., pp. 63-84. The choice of a distance function in an embodiment depends on the domains of the variables, i.e., feature spaces that the neural network models work with. However, there are also generic ways of determining distance and similarity between logical formulas, as described, for example, in the 2009 article, “Quantitative Logic,” by G. Wang, published in Information Sciences 179.3, pp. 226-247.

In one embodiment, a neural network model aims to predict if a radio-base-station equipment, for example, is going to have a failure in a next predetermined interval (e.g., the next 24 hours). The feature set consists of:
the number of times the external link between the site fails,
a service degradation counter,
a service unavailability counter,
a linear distance of the performance degradations which captures the derivative of the degradation,
LTE failure counter,
PLMN counter (number of landline calls),
power issue counter,
temperature issue counter.

The output is the likelihood of failure in the next 24 hours. The neural network has three layers (16, 3, 2). This problem can be approached as a classification problem, to predict whether a specific equipment characterized by an array of values for the above-listed features will fail the next 24 hours.

The neural network is trained collaboratively by federated learning using the validated devices (within the primary cluster) to produce a trained neural network. The last layer of this trained neural network has two weights, w1 and w2. The explanation with guarantees is a linear equation with boundaries for that layer (and for all other layers as well). If unvalidated client devices of the secondary cluster attempt a label-flipping attack, meaning that it indicates the equipment which is going to fail as equipment that's not going to fail, the last layer of a new model trained by the unvalidated clients would break the linear equation and the boundaries indicating the potential poisoning attack (i.e., misinformation).

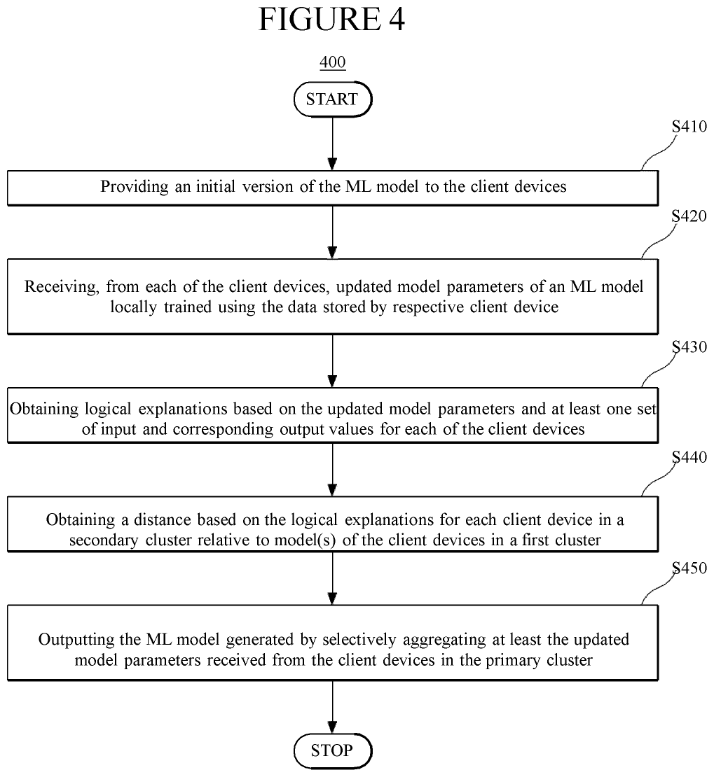

FIG. 4 is a flowchart of a method 400 performed by a server node (such as 110 or operating as federator 220) according to an embodiment. Method 400 includes providing an initial version of the ML model to the client devices at S410. Some clients (i.e., client1, client2, . . . clientM) are known (i.e., trustworthy, have been validated) pertaining to a main or primary cluster, while some other clients (i.e., clientM+1, clientM+2, . . . clientM+N) are not yet validated pertaining to a new or secondary cluster. Each client stores training data and generates a locally trained ML model.

Method 400 then includes receiving from each of the client devices updated model parameters of an ML model locally trained using the data stored therein, at S420.

Further, method 400 includes obtaining, logical explanations based on the updated model parameters and at least one set of input and corresponding output values for each of the client devices at S430. The at least one set of input and corresponding output values for each of the client devices can be inferred using the model parameters using known techniques as already mentioned. The method then includes obtaining a distance based on the logical explanations for each client device in the secondary cluster at S440. The distance measures a deviation of the ML model locally trained by the client device in the secondary cluster relative to one or more ML models trained on the data stored in client devices in the primary cluster. Here, “one or more ML models” covers both the situation in which there is a single client device in the primary cluster, and the situation in which the ML models from client devices in the primary cluster have been aggregated.

Then, at S450, the ML model generated by selectively aggregating at least the model parameters of the client devices in the primary cluster is output, while each client device in the secondary cluster is assessed based on its distance (e.g., whether it is trustworthy or not). Whether and how the model parameters of the client devices in the secondary cluster are aggregated may depend on a currently selected option (as previously discussed). Steps S410-S450 may be repeated using the ML model output at a first iteration as the initial version of the ML model provided to the client devices at a second iteration.

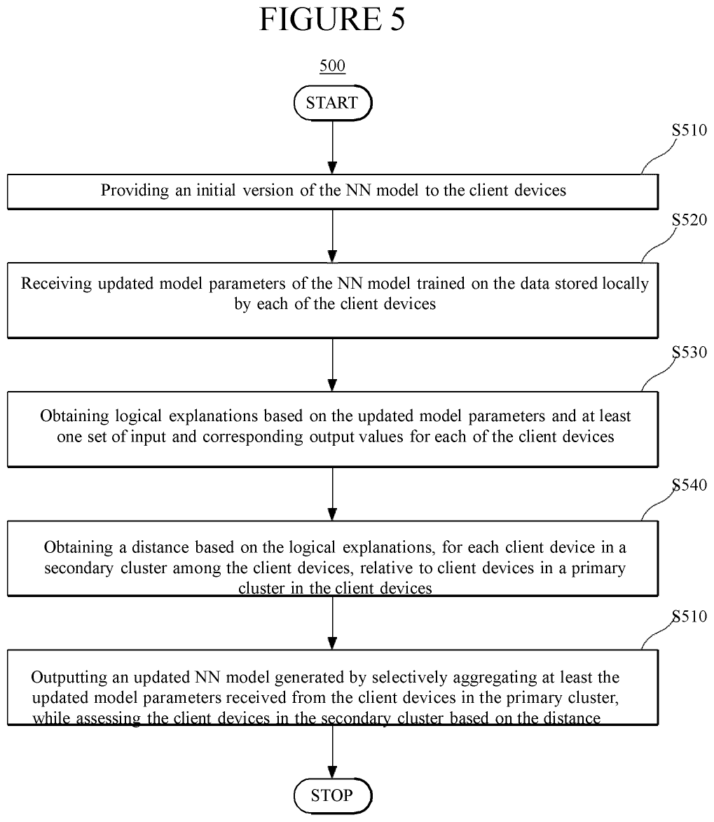

FIG. 5 is a flowchart of a method 500 performed by a server node (such as 110) for training a neural network, NN, model that predicts whether an equipment of a radio base station is going to fail during a next predetermined interval, using maintenance records of equipment similar to the equipment. The maintenance records, which include operational parameter histories and failure conditions, are stored in client devices (e.g., 210). Method 500 includes providing an initial version of the NN model to the client devices at S510, and then, at S520, receiving in response updated model parameters of the NN models trained locally on the data stored by each of the client devices.

Method 500 further includes obtaining logical explanations based on the updated model parameters and at least one set of input and corresponding output values for each of the client devices at S530. Method 500 then includes obtaining a distance based on logical explanations, for each client device in a secondary cluster included in the client devices relative to client devices in a primary cluster at S540. Method 500 outputs an updated NN model generated by selectively aggregating at least the updated model parameters received from the client devices in the primary cluster, while assessing the client devices in the secondary cluster based on the distance thereof at S550. The selective aggregation may depend on a pre-selected option and a comparison of the distance with thresholds (as previously described).

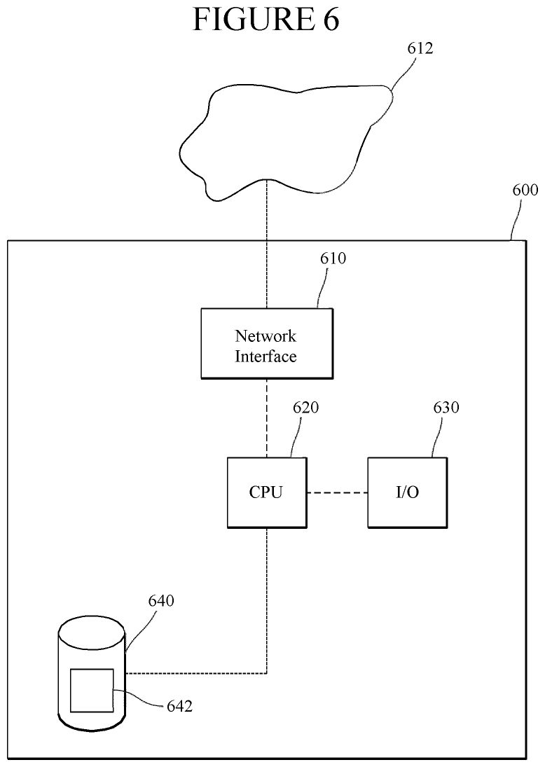

FIG. 6 illustrates a schematic diagram of an apparatus 600 configured to perform the above-described methods according to an embodiment. Apparatus 600 includes a communication interface 610 and a processing unit 620. The communication interface is configured to communicate with client devices via network 612. Apparatus 600 may also include a memory 640 and an operator interface 630. Memory 640 may store executable codes or a program 642, which, when executed by the processing unit, makes the processing unit perform any of the methods described in this section.

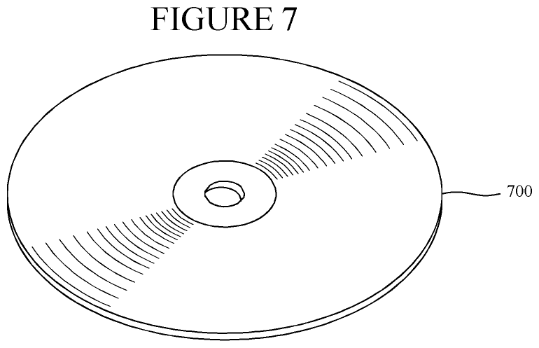

FIG. 7 depicts an electronic storage medium 700 on which computer program embodiments of the methods described in this section can be stored. Any suitable computer-readable medium may be utilized, including hard disks, CD-ROMs, digital versatile disc (DVD), optical storage devices, or magnetic storage devices such as floppy disk or magnetic tape. A carrier of the computer program may alternately be an electronic signal, an optical signal, a radio signal.

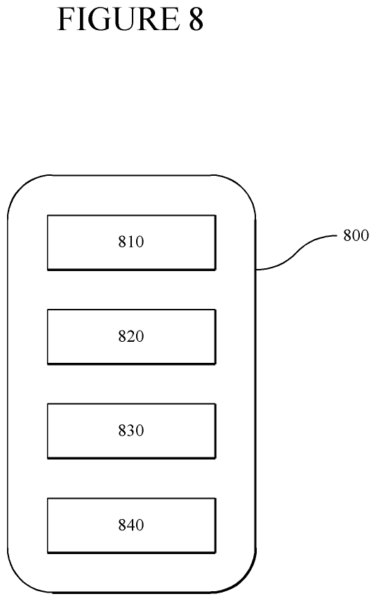

FIG. 8 illustrates a server node 800 for generating an ML model based on data stored in client devices in a communication network. Server node 800 includes a network interface 810, a logic-based explainer 820, a distance calculator 830 and a federator 840. The network interface 810 is configured to send an initial version of the ML model to the client devices, and to receive, from each of the client devices, updated model parameters of ML models locally trained using the data stored therein. The logic-based explainer 820 is configured to obtain logical explanations based on the updated model parameters and at least one set of input and corresponding output values for each of the client devices. The distance calculator 830 is configured to calculate a distance based on the logical explanations, for each client device in a secondary cluster among the client devices (the distance measuring a deviation of the ML model locally trained by the client device in the secondary cluster, relative to one or more ML models trained on the data stored in client devices in a primary cluster). The federator 840 is configured to selectively aggregate and output the ML model using at least the updated model parameters received from the client devices in the primary cluster, while assessing each client device in the secondary cluster based on the distance thereof.

The use of logical explanations (as minimal sets of features) for client predictions guarantee that a client will or will not yield a particular output given a particular input, allowing the definition of a deterministic distance metric between clients and their outputs based on model parameters (e.g., weights) and inputs. This approach allows for a better controlled and improved federation at the server node, which leads to better avoidance of poisoning and improved performance.

The disclosed embodiments provide methods and devices for generating a machine learning, ML, model using data stored in client devices while avoiding misinformation (detecting poisonous information). It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

As also will be appreciated by one skilled in the art, the embodiments may take the form of an entirely hardware embodiment or an embodiment combining hardware and software aspects. Further, the embodiments, e.g., the configurations and other logic associated with the charging process to include embodiments described herein, such as the methods associated with FIGS. 4 and 5, may take the form of a computer program product stored on a computer-readable storage medium having computer-readable instructions embodied in the medium. Other non-limiting examples of computer-readable media include flash-type memories or other known memories.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1. A method performed by a server node for generating a machine learning (ML) model while avoiding misinformation by selectively aggregating locally trained models trained locally using data stored in client devices, wherein the client devices are connected to the server node via a communication network, the method comprising:
providing an initial version of the ML model to the client devices;
receiving, from each of the client devices, updated model parameters of a respective ML model locally trained using the data stored therein starting from the initial version of the ML model;
obtaining logical explanations based on the updated model parameters and at least one set of input and corresponding output values for each of the client devices;
obtaining a distance based on the logical explanations, for each client device in a secondary cluster among the client devices, the distance measuring a deviation of the respective ML model locally trained by the client device in the secondary cluster, relative to one or more ML models trained on the data stored in client devices in a primary cluster among the client devices; and
outputting the ML model generated by selectively aggregating at least the updated model parameters received from the client devices in the primary cluster, while assessing each client device in the secondary cluster based on the distance thereof.

2. The method of claim 1, wherein
each of the one or more of the client devices in the secondary cluster has the distance less than a predetermined threshold, and
the updated model parameters received from one or more of the client devices in the secondary cluster are aggregated with the updated model parameters received from the client devices in the primary cluster to generate the ML model.

3. The method of claim 1, further comprising:
generating a secondary ML model based on the updated model parameters received from the client devices in the secondary cluster.

4. The method of claim 1, further comprising:
removing any of the client devices in the secondary cluster having the distance larger than a pre-defined distance threshold.

5. The method of claim 1, wherein the method is repeated using the ML model as the initial model.

6. The method of claim 1, wherein the ML model is a neural network and the model parameters are weights.

7. The method of claim 6, wherein the obtaining of the logical explanations includes logical encoding of the neural networks locally trained by the client devices in the secondary cluster, into mixed integer linear programming and the logical explanations are a minimal set of input features that guarantee respective outputs.

8. The method of claim 6, wherein the ML model predicts whether an equipment of a radio station is going to fail during a next predetermined interval, wherein the data stored in the client devices are maintenance records of equipment, with operational parameter histories including failures.

9. (canceled)

10. A method performed by a server node for generating a neural network (NN) model that predicts whether an equipment of a radio base station is going to fail during a next predetermined interval while avoiding misinformation by selectively aggregating locally trained NN models trained locally using maintenance records of equipment, the maintenance records being stored in client devices connected to the server node via a communication network, the method comprising:
providing an initial version of the NN model to the client devices;
receiving updated model parameters of the NN model locally trained on the maintenance records stored by each of the client devices, respectively;
obtaining logical explanations based on the updated model parameters and at least one set of input and corresponding output values for each of the client devices;
obtaining a distance based on the logical explanations, for each client device in a secondary cluster among the client devices, the distance measuring a deviation of the respective NN model locally trained by the client device in the secondary cluster, relative to one or more NN models trained on the maintenance records stored in client devices in a primary cluster among the client devices; and
outputting the NN model generated by selectively aggregating at least the updated model parameters received from at least the client devices in the primary cluster, while assessing each client device in the secondary cluster based on the distance thereof.

11. A server node for generating a machine learning (ML) model based on data stored in client devices in a communication network, the server node comprising processing circuitry, wherein the sever node is configured to:
provide an initial version of the ML model to the client devices;
receive, from each of the client devices, updated model parameters of a respective ML model locally trained using the data stored therein starting from the initial version of the ML model;
obtain logical explanations based on the updated model parameters and at least one set of input and corresponding output values for each of the client devices;
obtain a distance based on the logical explanations, for each client device in a secondary cluster among the client devices, the distance measuring a deviation of the respective ML model locally trained by the client device in the secondary cluster, relative to one or more ML models trained on the data stored in client devices in a primary cluster among the client devices; and
output the ML model generated by selectively aggregating at least the updated model parameters received from the client devices in the primary cluster, while assessing each client device in the secondary cluster based on the distance thereof.

12. The server node of claim 11, wherein the server node is further configured to generate the ML model by aggregating the updated model parameters received from one or more of the client devices in the secondary cluster with the updated model parameters received from the client devices in the primary cluster if each of the one or more of the client devices in the secondary cluster has the distance less than a predetermined threshold.

13. The server node of claim 11, wherein the server node is further configured to generate a secondary ML model based on the updated model parameters received from the client devices in the secondary cluster.

14. The server node of claim 11, wherein the server node is further configured to remove any of the client devices in the secondary cluster that has the distance larger than a pre-defined distance threshold.

15. The server node of claim 11, wherein the ML model is a federated learning model.

16. The server node of claim 11, wherein the ML model is a neural network and the model parameters are weights.

17. The server node of claim 16, wherein, when obtaining the logical explanations, the processing circuitry causes a logical encoding of the neural networks, locally trained by the client devices in the secondary cluster, into mixed integer linear programming, the logical explanations being a minimal set of input features that guarantee respective outputs.

18. The server node of claim 17, wherein the ML model predicts whether an equipment of a radio station is going to fail during a next predetermined interval, wherein the data stored in the client devices are maintenance records of equipment, with operational parameter histories including failures.

19. A non-transitory computer readable storage medium storing a computer program for configuring a server node to perform the method of claim 1.

20. A non-transitory computer readable storage medium storing a computer program for configuring a server node to perform the method of claim 10.

21-22. (canceled)

23. A server node for generating a neural network (NN) model that predicts whether an equipment of a radio base station is going to fail during a next predetermined interval while avoiding misinformation by selectively aggregating locally trained NN models trained locally using maintenance records of equipment, the maintenance records being stored in client devices connected to the server node via a communication network, the serving node comprising processing circuitry, wherein the server node is configured to:
provide an initial version of the NN model to the client devices;
receive updated model parameters of the NN model locally trained on the maintenance records stored by each of the client devices, respectively;
obtain logical explanations based on the updated model parameters and at least one set of input and corresponding output values for each of the client devices;
obtain a distance based on the logical explanations, for each client device in a secondary cluster among the client devices, the distance measuring a deviation of the respective NN model locally trained by the client device in the secondary cluster, relative to one or more NN models trained on the maintenance records stored in client devices in a primary cluster among the client devices; and
output the NN model generated by selectively aggregating at least the updated model parameters received from at least the client devices in the primary cluster, while assessing each client device in the secondary cluster based on the distance thereof.
